(19) United States
(12) Patent Application Publication
(10) Pub. No.: US 2006/0067605 A1
(43) Pub. Date: Mar. 30, 2006

(54) Photonic crystal optical temperature measuring system

(76) Inventors: Laura Wills Mirkarimi, Sunol, CA (US); Mihail M. Sigalas, Santa Clara, CA (US); Annette C. Grot, Cupertino, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/954,748

(22) Filed: Sep. 30, 2004

(51) Int. Cl. G02B 6/00

(52) U.S. Cl. 385/12

(57) ABSTRACT

A photonic crystal optical temperature measuring system and a method for measuring the temperature of an object. The photonic crystal optical temperature measuring system has at least one photonic crystal temperature sensor having a resonant cavity, the resonant frequency of which is a function of the temperature of the resonant cavity.

### DESCRIPTION OF RELATED ART

The ability to measure the temperature of a very small device is important in many applications. For example, in the semiconductor integrated circuit (IC) industry it is often desirable to monitor the temperature of an integrated circuit to ensure that it is operating properly. Also, the manufacture of semiconductor integrated circuits depends on the growth of materials, and a strong influence on deposition rates, kinetics and composition of the final film is the deposition temperature. Because of the importance of deposition temperature, improved thermal heaters for deposition systems are being developed on a regular basis.

One important technique for measuring deposition temperature requires evaluating temperature profiles over large area heaters (greater than twelve inches). Good temperature uniformity leads to uniformity in the thickness, composition and microstructure of the final film; which, in turn leads to improvements in the yield of electronic and optical devices incorporating semiconductor integrated circuits. A thermocouple wafer having a plurality of thermocouples embedded in a silicon wafer is often used to measure the temperature profiles.

It is known that optical techniques can also be used to measure temperature. For example, it is known that by using a reflectivity signal from several dielectric materials, temperature can be determined if one of the dielectric materials exhibits a change in refractive index with temperature change. It has also been suggested that a physical parameter such as temperature can be measured with resonant frequency using resonators such as ring resonators.

### SUMMARY OF THE INVENTION

In accordance with the invention, a photonic crystal optical temperature measuring system and a method for measuring the temperature of an object is provided. The photonic crystal optical temperature measuring system typically has at least one photonic crystal temperature sensor apparatus having a resonant cavity, the resonant frequency of which is a function of the temperature of the resonant cavity. Typically, a wavelength source illuminates the resonant cavity, and a detector detects the resonant frequency of the resonant cavity. A converter converts the detected resonant frequency into a temperature for providing a measure of the temperature of an object in the vicinity of the resonant cavity.

### BRIEF DESCRIPTION OF THE DRAWINGS

Furthermore, the invention provides embodiments and other features and advantages in addition to or in lieu of those discussed above. Many of these features and advantages are apparent from the description below with reference to the following drawings.

FIG. 1 is a schematic top view of a photonic crystal having a resonant cavity design according to an embodiment in accordance with the invention;

FIG. 2 is a schematic cross-sectional side view of a photonic crystal temperature sensor apparatus according to a further embodiment in accordance with the invention;

FIG. 3 schematically illustrates a photonic crystal optical temperature measuring system according to an embodiment in accordance with the invention;

FIG. 4 schematically illustrates a photonic crystal optical temperature measuring system according to a further embodiment in accordance with the invention;

FIG. 5 is a graph that illustrates a shift in frequency with change in refractive index for the photonic crystal temperature sensor apparatus of FIG. 2 incorporating the photonic crystal resonant cavity design of FIG. 1;

FIG. 6 is a schematic top view of a photonic crystal having a resonant cavity design according to an embodiment in accordance with the invention;

FIG. 7 is a graph that illustrates a shift in frequency with change in refractive index for the photonic crystal temperature sensor apparatus of FIG. 2 incorporating the photonic crystal resonant cavity design of FIG. 6; and

FIG. 8 is a flowchart that illustrates a method for measuring the temperature of an object according to an embodiment in accordance with the invention.

### DETAILED DESCRIPTION OF THE EXEMPLARY EMBODIMENTS OF THE INVENTION

Embodiments in accordance with the invention provide a photonic crystal optical temperature measuring system and a method for measuring the temperature of an object.

Photonic crystals are engineered structures that can be used to control the propagation of light. Photonic crystal resonators having a resonant cavity formed in a photonic crystal slab waveguide have been proposed for numerous applications including wavelength filtering, out of plane coupling and modulators. Photonic crystal resonators can provide high Q and are extremely compact, commonly having an area of less than 10 μm².

The invention provides a photonic crystal optical temperature measuring system that includes a photonic crystal resonator that functions as a photonic crystal temperature sensor apparatus. For a photonic crystal resonator having a particular resonant cavity design, a specific resonant frequency is obtained at a particular temperature. The resonant frequency of the resonant cavity changes as the temperature of the resonant cavity changes. A converter converts a detected resonant frequency into a temperature for providing a measure of the temperature of an object in the vicinity of the resonant cavity.

FIG. 1 is a schematic top view of a photonic crystal having a resonant cavity design according to an exemplary embodiment in accordance with the invention. The photonic crystal is generally designated by reference number 100, and comprises a two-dimensional photonic crystal slab waveguide 102 having a periodic lattice formed by an array of circular air holes 104 extending through slab 102 from a top surface to a bottom surface thereof. A circular-shaped air hole of reduced diameter is provided in slab 102 to define resonant cavity 106.

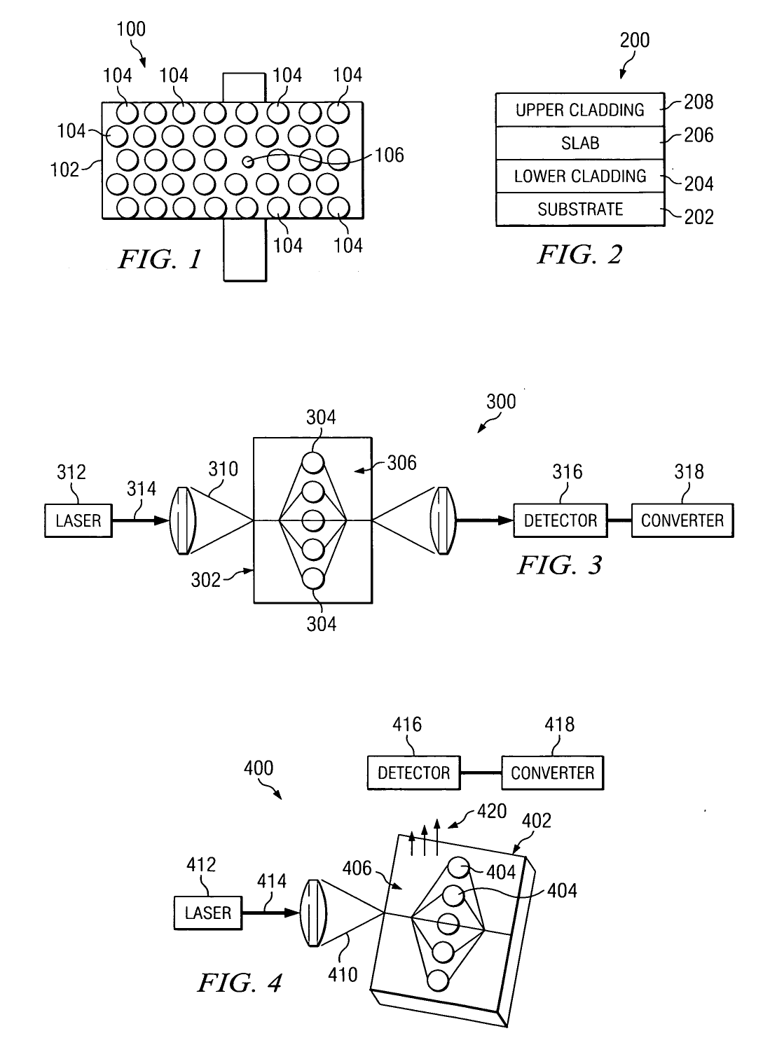

FIG. 2 is a schematic cross-sectional side view of a photonic crystal temperature sensor apparatus according to a further exemplary embodiment in accordance with the invention. The photonic crystal temperature sensor apparatus is generally designated by reference number 200, and is composed of a material stack that includes substrate 202, lower cladding layer 204, photonic crystal slab waveguide 206, and upper cladding layer 208. Lower cladding layer 204 covers a lower surface of photonic crystal slab waveguide 206, and upper cladding layer 208 covers an upper surface of photonic crystal slab waveguide 206.

Photonic crystal slab waveguide 206, may be implemented as photonic crystal slab waveguide 102 illustrated in FIG. 1, and comprises a material having a relatively high index of refraction n that is equal to or greater than about 3, for example, 3-4, so as to obtain an appropriate index ratio to form a photonic crystal resonator with air holes. Photonic crystal slab waveguide 206 is also formed of a material that has a temperature sensitive refractive index; and the material is preferably a single crystalline or similar material that transmits light.

Some materials that satisfy the above criteria for a photonic crystal slab waveguide include Si (n=3.5, dn/dT (thermo-optic coefficient)=1.8×10⁻⁴K⁻¹); Ge or compound semiconductors including GaAs (n=3.4, dn/dT=2.5×10⁻⁴K⁻¹); InP (n=3.1, dn/dT=0.8×10⁻⁴K⁻¹); CdS and CdSe.

The index of refraction of upper cladding layer 208 (n_{upper cladding}) and the index of refraction of lower cladding layer 204 (n_{lower cladding}) should be less than the index of refraction of photonic crystal slab waveguide 206 (n_{slab waveguide}) in order to confine light in the plane of photonic crystal slab waveguide 206. For example, if photonic crystal slab waveguide 206 is formed of Si, lower cladding layer 204 can be formed of a material having an index of refraction of about 1.5 such as SiO₂ or spin on glass, and upper cladding layer 208 can be formed of a material having an index of refraction of about 1.4-1.5, such as SiO₂, spin on glass or another polymer-based material. Substrate 202 preferably comprises a Si or other semiconductor substrate.

FIG. 3 schematically illustrates a photonic crystal optical temperature measuring system according to an exemplary embodiment in accordance with the invention. The system is generally designated by reference number 300 and is provided to monitor the temperature of an object 302, for example, a semiconductor integrated circuit. A plurality of photonic crystal temperature sensor apparatus 304, each of which may be implemented as photonic crystal temperature sensor apparatus 200 illustrated in FIG. 2, are provided in the vicinity of object 302, for example, by being positioned on object 302, to define an array of photonic crystal temperature sensor apparatus, generally designated by reference number 306.

The resonant cavity in the photonic crystal slab waveguide of each photonic crystal temperature sensor apparatus 304 in array 306 is connected to a ridge waveguide 310 that couples light from an optical fiber, schematically illustrated at 314 connecting a wavelength source 312 such as a tunable laser or a broad band light source to each resonant cavity. A detector 316 detects the resonant frequency of each of the resonant cavities. A suitable resonant frequency detector comprises a scanning monochromator for a broad band light source and a solid state semiconductor detector such as Si for visible wavelengths, Ge for visible to ˜1.5 μm and InGaAs for over infrared wavelengths. For the tunable laser, a solid state semiconductor laser is all that is needed. A converter 318 converts the detected resonant frequency to a temperature for providing a measure of the temperature of object 302. The conversion is based on the calibration of the photonic crystal resonant cavity frequency at known temperatures. A simple algorithm based on the calibration is used in the converter to perform the calculation quickly.

In the particular configuration illustrated in FIG. 3, light is coupled into and out of array 306 from the photonic crystal slab waveguides containing the resonant cavities in each of the plurality of photonic crystal temperature sensor apparatus 304. The output signal can also be detected from above the plane of the photonic crystal slab waveguides. FIG. 4 schematically illustrates a photonic crystal optical temperature measuring system according to a further exemplary embodiment in accordance with the invention. System 400 illustrated in FIG. 4, is generally similar to system 300 illustrated in FIG. 3, however, in system 400, the output signal is detected from above the planes of the resonant cavities in the photonic crystal slabs waveguides of the plurality of photonic crystal temperature sensor apparatus 404 as shown by arrows 420.

According to yet further exemplary embodiments in accordance with the invention, light can be coupled into the array of photonic crystal temperature sensor apparatus by techniques that use gratings or other light coupling structures.

The out of plane output signal in photonic crystal optical temperature measuring system 400 can be enhanced by adjusting n_{upper cladding} to be higher than n_{lower cladding}. Several upper cladding materials can further enhance vertical coupling such as Si₃N₄

(n=1.9), MgO (n=1.8), Al₂O₃ (n=1.76), ZrSiO₄ (n=1.95), SrO (n˜2.0), Ta₂O₅ (n=2.2), SrₓBa₍₁₋ₓ₎TiO₃ (n=2.2) and TiO₂ (n=2.4-2.7) as are described in commonly assigned, co-pending application Ser. No. 10/910,216, filed on Aug. 3, 2004, and entitled PHOTONIC CRYSTAL RESONATOR APPARATUS WITH IMPROVED OUT OF PLANE COUPLING, the disclosure of which is hereby incorporated by reference.

Photonic crystal temperature sensor apparatus 200 may be fabricated by patterning a resist with the design of the resonant cavity using electron beam lithography or another nano-lithography technique. The pattern is then transferred into the upper cladding layer by a selective etch technique. The reverse pattern can also be fabricated so that a metal lift-off technique can be used to prepare a hard metal mask. This reverse pattern procedure may be particularly useful in order to obtain good etch selectivity when good etch selectivity does not exist between the resist and the upper cladding layer.

A selective etch is used to etch away the Si to form the air holes and resonant cavity in the photonic crystal slab without removing the upper cladding layer. The etch may stop on the lower cladding layer or proceed through the lower cladding layer, depending on the selectivity of etches between the photonic crystal slab and the lower cladding layer.

A lithographic technique for fabricating a temperature sensitive photonic crystal slab waveguide formed of Si provides a low cost manufacturing procedure. The sensitivity and data points also increase substantially with a Si-based photonic crystal temperature sensor apparatus as compared to a thermocouple wafer. A Si-based photonic crystal temperature sensor apparatus can also enable very efficient characterization of temperature profiles in silicon manufacturing tooling that use thin film deposition chambers.

The sensitivity of the temperature measurement depends on many factors including Δn/Δλ, the ability to resolve a resonant peak position and the thermo-optic coefficient (dn/dT). For example, in order to sense a one degree change in temperature in a Si-based photonic crystal temperature sensor apparatus, (dn/dT=1.8×10⁻⁴K⁻¹) with Δn/Δλ, it is necessary to resolve a λ of 0.27 nm. Increasing the thermo-optic coefficient by a factor of 4 requires resolving only 1 nm shifts in resonant frequency. As the Q in a cavity increases, and the full width at half maximum (FWHM) of the intensity of the resonant wavelength signal decreases, the peak position can be somewhat easier to resolve. Furthermore, by providing an array of photonic crystal temperature sensor apparatus, and by detecting the change in resonant frequency in each of the plurality of photonic crystal temperature sensor apparatus at once and/or by using different designs of resonators that are referenced to one another, temperature measuring precision can be improved. Because of the small area occupied by each photonic crystal temperature sensor apparatus (about 4 μm², the number of photonic crystal temperature sensor apparatus incorporated into the array can be 10-20 or more, depending on the requirements of a particular application. The small size of the photonic crystal temperature sensor apparatus also suggests applications wherein a temperature sensor may be located on electrical or optical devices for in-situ temperature sensing.

Several mechanisms can be used to improve the design of the photonic crystal temperature sensor apparatus. For example, a material for the photonic crystal slab waveguide can be selected that has a larger thermo-optic effect and a refractive index change that is larger per temperature change. Another improvement to a silicon-based temperature sensor apparatus would be to select amorphous Si (a-Si:H; dn/dT=3.4×10⁻⁴K⁻¹) or silicon carbide (SiC; dn/dT=7.1×10⁻⁴K⁻¹) compared to Si (dn/dT=1.8×10⁻⁴K⁻¹). In the case of SiC, however, the refractive index is approximately 2.7 and this relatively low refractive index may reduce the Q in the resonant cavity, thereby necessitating some tradeoff.

Another mechanism for improving the photonic crystal temperature sensor apparatus is to design a resonant cavity having a very high Q. A photonic crystal temperature sensor apparatus incorporating Si photonic crystal slab waveguide 102 illustrated in FIG. 1, provides a very high Q for a photonic crystal slab waveguide having a thickness of 0.6 a (a is the lattice constant), air holes 104 having a radius of 0.29 a, resonant cavity 106 having a radius of 0.17 a and wherein the high index photonic crystal slab waveguide 102 is placed on top of a lower cladding layer having a refractive index n=1.4 (e.g., SiO₂).

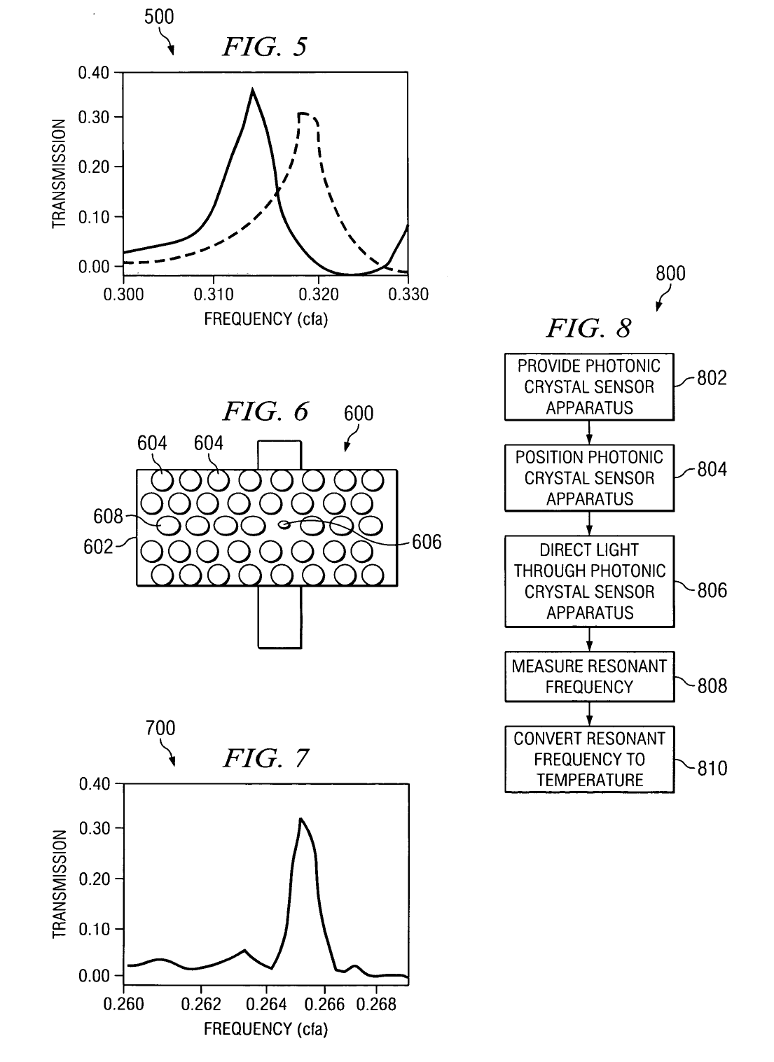

FIG. 5 is a graph, generally designated by reference number 500 that illustrates a shift in frequency with change in refractive index for photonic crystal temperature sensor apparatus 200 illustrated in FIG. 2 and incorporating a photonic crystal slab waveguide having the photonic crystal resonant cavity design illustrated in FIG. 1 and having the above described characteristics. Photonic crystal slab waveguide 102 has a high index of refraction of 3.4 (solid line) and 3.3 (dashed line). As shown in FIG. 5, the resonant frequency, the Q factor and the transmission are 0.311, 57 and 0.37, respectively, for n=3.4, and 0.318, 55 and 0.32, respectively, for n=3.3. There is a 2.25% shift in the frequency for a 2.94% shift in the refractive index. The Q-factor of the resonant cavity will increase by increasing the thickness of the photonic crystal.

FIG. 6 is a schematic top view of a photonic crystal having a resonant cavity design according to an exemplary embodiment in accordance with the invention. In FIG. 6, photonic crystal 600 comprises a photonic crystal slab waveguide 602 having an array of air holes 604 and a resonant cavity 606 that is smaller than air holes 604. Photonic crystal slab waveguide 602, however, further includes a line of elliptical-shaped air holes 608 in the row of air holes that includes resonant cavity 606. Elliptical-shaped air holes 608 and resonant cavity 606 are elongated by an elongation factor e, and, at the same time, the two halves of the PC (here, it is assumed that the PC is separated into two halves by the row of elliptical-shaped air holes) are moved away from each other by the same amount of e.

FIG. 7 is a graph that illustrates a shift in frequency with change in refractive index for a photonic crystal resonator apparatus incorporating the photonic crystal resonant cavity design of FIG. 6. The graph is designated by reference number 700 and illustrates the results for a resonant cavity having a radius of 0.17 a and an elongation factor e=0.125 a. The photonic crystal comprises 9 rows of air holes along the direction of light propagation. The calculated Q-factor was 205. By increasing the number of rows of air holes in the photonic crystal slab waveguide, the calculated Q-factor can reach values in excess of 10,000.

FIG. 8 is a flowchart that illustrates a method for measuring the temperature of an object according to a further exemplary embodiment in accordance with the invention. The method is generally designated by reference number 800 and begins by providing at least one photonic crystal temperature sensor apparatus having a photonic crystal slab waveguide including a resonant chamber, the resonant frequency of which is a function of the temperature of the resonant cavity (Step 802). The at least one photonic crystal temperature sensor apparatus is positioned in the vicinity of an object whose temperature is to be measured (Step 804), and light is directed through the resonant chamber from a wavelength source (Step 806). The resonant frequency of the resonant cavity is measured (Step 808), and the measured resonant frequency is converted into a temperature (Step 810). The converted temperature corresponds to the temperature of the object.

While what has been described constitute exemplary embodiments in accordance with the invention, it should be recognized that the invention can be varied in numerous ways without departing from the scope thereof. For example, although in the exemplary embodiments in accordance with the invention described herein, the photonic crystal slab waveguides include air holes, the holes can also be filled with another gas or a vacuum. Because embodiments in accordance with the invention can be varied in numerous ways, it should be understood that the invention should be limited only in so far as is required by the scope of the following claims.

1. A photonic crystal optical temperature measuring system, comprising:
at least one photonic crystal temperature sensor apparatus, the at least one photonic crystal temperature sensor apparatus comprising a photonic crystal slab waveguide having a resonant cavity, a resonant frequency of the resonant cavity being a function of a temperature of the resonant cavity;
a wavelength source for illuminating the resonant cavity;
a detector for detecting the resonant frequency of the resonant cavity; and
a converter for converting the detected resonant frequency to temperature.

2. The system according to claim 1, wherein the wavelength source comprises a light source selected from the group consisting of a tunable laser and a broad band light source.

3. The system according to claim 1, wherein the photonic crystal slab waveguide has an index of refraction at least as high as about three.

4. The system according to claim 3, wherein the photonic crystal slab waveguide has an index of refraction of from about 3 to about 4.

5. The system according to claim 1, wherein the photonic crystal slab waveguide comprises a material selected from the group consisting of Si, Ge, GeAs, InP, CdS and CdSe.

6. The system according to claim 1, wherein the photonic crystal slab waveguide comprises a lattice of holes, and wherein the resonant cavity comprises a hole having a radius less than the radius of the holes of the lattice of holes.

7. The system according to claim 1, wherein the at least one photonic crystal temperature sensor apparatus further comprises:
an upper cladding layer on an upper surface of the photonic crystal slab waveguide; and
a lower cladding layer on a lower surface of the photonic crystal slab waveguide,
wherein the index of refraction of the photonic crystal slab waveguide is greater than the indices of refraction of the upper cladding layer and the lower cladding layer.

8. The system according to claim 1, wherein the at least one photonic crystal temperature sensor apparatus comprises a plurality of photonic crystal temperature sensor apparatus arranged in an array.

9. The system according to claim 1, wherein the detector detects light output from the at least one photonic crystal temperature sensor apparatus through the photonic crystal slab waveguide of the at least one photonic crystal temperature sensor apparatus.

10. The system according to claim 1, wherein the detector detects light output from the at least one photonic crystal temperature sensor apparatus outside a plane of the photonic crystal slab waveguide of the at least one photonic crystal temperature sensor apparatus.

11. A photonic crystal temperature sensor apparatus, comprising:
a photonic crystal slab waveguide having a resonant cavity, a resonant frequency of the resonant cavity being a function of a temperature of the resonant cavity;
an upper cladding layer on an upper surface of the photonic crystal slab; and
a lower cladding layer on a lower surface of the photonic crystal slab.

12. The apparatus according to claim 11, wherein the photonic crystal slab waveguide has an index of refraction at least as high as about three.

13. The apparatus according to claim 12, wherein the photonic crystal slab waveguide has an index of refraction of from about 3 to about 4.

14. The apparatus according to claim 11, wherein the photonic crystal slab waveguide comprises a material selected from the group consisting of Si, Ge, GeAs, InP, CdS and CdSe.

15. The apparatus according to claim 12, wherein the index of refraction of the photonic crystal slab waveguide is greater than the indices of refraction of the upper cladding layer and the lower cladding layer.

16. The apparatus according to claim 11, wherein the photonic crystal slab waveguide comprises a lattice of holes, and wherein the resonant cavity comprises a hole having a radius less than the radius of the holes of the lattice of holes.

17. A method for measuring a temperature of an object, comprising:
providing at least one photonic crystal temperature sensor apparatus, the at least one photonic crystal temperature sensor apparatus having a resonant cavity, a resonant frequency of the resonant cavity being a function of a temperature of the resonant cavity;
positioning the at least one photonic crystal temperature sensor apparatus in the vicinity of the object;
directing light through the resonant cavity;
measuring the resonant frequency of the resonant cavity; and
converting the measured resonant frequency to a temperature.

18. The method according to claim 17, wherein positioning the at least one photonic crystal temperature sensor apparatus in the vicinity of the object comprises positioning the at least one photonic crystal sensor apparatus on the object.

19. The method according to claim 17, wherein the object comprises a semiconductor integrated circuit.

20. The method according to claim 17, wherein the at least one photonic crystal temperature sensor apparatus comprises a plurality of photonic crystal temperature sensor apparatus.

21. The method according to claim 17, wherein directing light through the resonant cavity comprises directing light through the resonant cavity from one of a tunable laser and a broad band light source.

22. The method according to claim 17, wherein measuring the resonant frequency of the resonant cavity comprises detecting light output from the at least one photonic crystal temperature sensor apparatus.
